(19) United States
(12) Patent Application Publication
(10) Pub. No.: US 2006/0185154 A1
(43) Pub. Date: Aug. 24, 2006

(54) Method of manufacturing secondary battery electrode, apparatus for manufacturing the same and secondary battery electrode

(75) Inventors: Takamitsu Saito, Kanagawa-ken (JP); Hideaki Horie, Kanagawa-ken (JP); Osamu Shimamura, Kanagawa-ken (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 10/560,504

(22) PCT Filed: May 31, 2004
(86) PCT No.: PCT/JP04/07865

§ 371 Date: Dec. 13, 2005

(30) Foreign Application Priority Data
Jun. 18, 2003 (JP) 2003-174136

(51) Int. Cl. H01M 6/00; B23P 13/00

(52) U.S. Cl. 29/623.2; 29/730; 29/2

(57) ABSTRACT

With a method of manufacturing a secondary battery electrode having active material (111) on a current collector (110), a computer (100) acquires a deposition pattern (PT) for depositing a plurality of kinds of active materials, different in electrical characteristic, onto discrete areas of a current collector, and the computer allows injection nozzles (108) to inject the plurality of kinds of active materials onto the current collector as multiple particles (P), respectively, to be deposited thereon, thereby forming an active material layer.

### TECHNICAL FIELD

The present invention relates to a method of manufacturing a secondary battery electrode, an apparatus for manufacturing the same and a secondary battery electrode and, more particularly, to a method of manufacturing a secondary battery electrode to enable an arbitrary charging and discharging characteristic to be provided, an apparatus for manufacturing the same, and a secondary battery electrode.

### BACKGROUND ART

Recently, an electric vehicle (EV), a hybrid vehicle (HEV) and a fuel cell powered vehicle (FCV) have been put into practical use, and research and development works have been undertaken at a rapid pace to realize a battery serving as a prime power source of these vehicles. These batteries are required to bear extremely severe conditions such as an ability of charging and discharging on repeated cycles, a high power output and a high energy density.

To satisfy such requirements, research and development works have also been undertaken to provide a thin type laminate battery. The thin type laminate battery is comprised of a lithium ion battery that has an outer casing formed of a laminate sheet. As the laminate sheet, a multi-layered laminate sheet is used which includes a layered structure of a metallic film, such as an aluminum foil adapted to avoid gases such as steam and oxygen from exchanging inside of or outside of the outer casing, a resin film such as polyethylene terepthalate for physically protecting the metallic film, and a thermally welding resin film such as ionomer. The outer casing has a planar shape with a rectangular configuration and has a thickness in the order of approximately several millimeters. The outer casing accommodates therein plate-like, positive electrode and negative electrode, and liquid-like electrolyte is sealed.

Japanese Patent Application Laid-Open Publication No. 2003-151526 proposes to provide a structure wherein thin-type laminate batteries are used and connected in series or in parallel in multiple stages to form a battery.

Japanese Patent Application Laid-Open Publication No. 2002-110239 discloses macromer between ethylene oxide and propylene oxide as polymer electrolyte raw material.

### DISCLOSURE OF INVENTION

However, according to the studies conducted by present inventors, since the thin type laminate battery is composed of the positive electrode and the negative electrode which when manufacturing the same, are formed by coating positive electrode material and negative electrode material onto a current collector foil with a tool composed of a so-called coater, with a difficulty being encountered in strictly managing the thickness of a positive electrode layer and a negative electrode layer making it hard to manufacture a secondary battery with a uniform charging and discharging characteristic.

The present invention has been completed upon the above studies conducted by the present inventors and has an object to provide a method of manufacturing a secondary battery electrode which is possible to provide an arbitrary charging and discharging characteristic, a manufacturing apparatus for the same, and a secondary battery electrode.

That is, the present invention has been completed upon knowledge in that when letting plural kinds of active materials, different in electrical characteristic, deposit on a current collector, a pattern based on which these active materials are (to be) deposited is considered whereupon letting the active materials deposit on discrete areas in accordance with such a pattern enables the formation of an electrolyte with a high quality on a high productivity in a stable manner.

In particular, knowledge has been yielded wherein when obtaining a particular charging and discharging characteristic, no electrode is formed by simply mixing a plurality of different active materials so as to obtain such a characteristic but ingredients of respective active materials are formulated as optimum propellants (inks) which are injected and deposited onto discrete areas of the current collector.

For example, in order to obtain the particular charging and discharging characteristic, it is supposed that there is a need for using olivine type iron olivine (LiFePO₄) with an average charging and discharging voltage of 3.5 V and spinel type lithium manganese (LiMn₂O₄) with an average charging and discharging voltage of 3.9 V.

Here, the ingredients per se of olivine type iron olivine (LiFePO₄) are exceedingly low in electrical conductivity and, hence, a large amount of conductive materials needs to be used (at a ratio greater than 10% by weight). Further, these materials have a particle diameter of a value in the order of submicron size and have an extremely large specific surface area, making it necessary to use a large amount of binders. On the other hand, since the electrical conductivity of the ingredient per se of spinel type lithium manganese (LiMn₂O₄) is comparatively favorable, only a several percentage by weigh of conductive material may suffice to be mixed.

Assuming that these materials are simply mixed, the ink needs to be adjusted to meet the requirement of iron olivine that needs large amounts of conductive material and binders. On the other hand, when formulating respective materials to form another ink, two kinds of inks may suffice to be prepared under the highest efficiencies optimized for the respective materials.

And, even when two kinds of materials different in charging and discharging characteristic are deposited on discrete areas of the current collector, supposing that small deposit (deposited) patterns are repeatedly formed on the current collector, electric current and voltage are equalized on resulting surfaces of the patterns. Therefore, this results in a capability of obtaining a favorable charging and discharging characteristic of a battery.

Supposing that when forming such a discharging pattern, the ink uses materials with large and small expansion and contraction ratios, material with the large expansion and contraction ratio may suffice to be formed in a pattern with a small surface area, and material with the small expansion and contraction ratio may suffice to be formed in a pattern with a large surface area. This alleviates stress resulting from expansion and contraction during charging and discharging cycles, resulting in am improvement over a life characteristic of the battery.

Accordingly, by determining various factors, such as the kind of active material to be deposited onto the current collector, and a size and shape of the area on which the ink is to be deposited for thereby producing a deposition pattern, a secondary battery electrode is enabled to have a desired charging and discharging characteristic.

To achieve such an object, in one aspect of the present invention, there is provided a method of manufacturing a secondary battery electrode having active materials on a current collector, comprising: letting a computer acquire a deposition pattern for depositing a plurality of kinds of active materials, different in electric characteristic, onto discrete areas of a current collector, respectively; and letting the computer allow injection nozzles to inject the plurality of kinds of active materials, as multiple particles, onto the current collector for deposition thereon, respectively, in accordance with the deposition pattern for thereby forming an active material layer.

Further, in another aspect of the present invention, there is provided an apparatus for manufacturing a secondary battery electrode having active materials on a current collector, comprising: a computer generating a deposition pattern for depositing a plurality of kinds of active materials, different in electric characteristic, onto discrete areas of a current collector, respectively; a memory device storing the deposition pattern generated by the computer; injection nozzles injecting the plurality of kinds of active materials, as multiple particles, onto the current collector, respectively, in accordance with the deposition pattern stored in the memory device; and a heater drying the plurality of kinds of active materials deposited onto the current collector, respectively.

Furthermore, in the other aspect of the present invention, there is provided a secondary battery electrode comprising: a current collector; and an electrode layer formed on the current collector and including a plurality of kinds of active materials different in electrical characteristic, the electrode layer being structured such that graphics associated with the plurality of kinds of active materials, respectively, are located on discrete areas of the current collector.

Other and further features, advantages, and benefits of the present invention will become more apparent from the following description taken in conjunction with the following drawings.

### BRIEF DESCRIPTION OF DRAWINGS

FIG. 1 is a block diagram illustrating a schematic structure of a manufacturing apparatus for a secondary electrode of an embodiment according to the present invention;

FIG. 2 is a view illustrating a deposition pattern (pattern specified for injection and deposition) used in the manufacturing apparatus of the presently filed embodiment;

FIG. 3 is a flowchart illustrating a sequence of manufacturing method for the secondary battery electrode of the presently filed embodiment;

FIG. 4 is a top view of the secondary battery electrode (bipolar electrode) of the presently filed embodiment;

FIG. 5 is a perspective view of a secondary battery employing the secondary battery electrode of the presently filed embodiment;

FIG. 6A is a plan view of a battery unit employing the secondary battery of the presently filed embodiment;

FIG. 6B is a cross sectional view taken online A-A of FIG. 6A;

FIG. 6C is a cross sectional view taken online B-B of FIG. 6A;

FIG. 7 is a perspective view of a combined battery employing the battery unit of the presently filed embodiment;

FIG. 8 is a sidewise typical view of a vehicle on which the battery unit or the combined battery is installed, in the presently filed embodiment;

FIG. 9 is a view illustrating a deposition pattern in Example 1 of the presently filed embodiment;

FIG. 10 is a view, illustrating a charging and discharging curve of a positive electrode obtained in Example 1 of the presently filed embodiment, wherein the abscissa designates a discharging depth of DOD and the ordinate designates a voltage V;

FIG. 11 is a view, illustrating a charging and discharging curve of a battery including the positive electrode obtained in Example 1 and a negative electrode formed of graphite of the presently filed embodiment, wherein the abscissa designates a discharging depth of DOD and the ordinate designates a voltage V;

FIG. 12 is a view illustrating a deposition pattern in Example 2 of the presently filed embodiment;

FIG. 13 is a view, illustrating a charging and discharging curve of a negative electrode obtained in Example 2 of the presently filed embodiment, wherein the abscissa designates a depth of discharging DOD and the ordinate designates a voltage V;

FIG. 14 is a view, illustrating a charging and discharging curve of a battery including a negative electrode obtained in Example 2 and a positive electrode formed of spinel manganese of the presently filed embodiment, wherein the abscissa designates a capacity and the ordinate designates a voltage V;

FIG. 15 is a view illustrating a deposition pattern in Comparative Example 1 of the presently filed embodiment;

FIG. 16 is a view, illustrating a charging and discharging curve of a battery obtained in Comparative Example 1 of the presently filed embodiment, wherein the abscissa designates a capacity and the ordinate designates a voltage V;

FIG. 17 is a view illustrating a deposition pattern in Comparative Example 2 of the presently filed embodiment;

FIG. 18 is a view, illustrating a charging and discharging curve of a battery obtained in Comparative Example 2 of the presently filed embodiment, wherein the abscissa designates a capacity and the ordinate designates a voltage V;

FIG. 19 is a view illustrating a deposition pattern in Comparative Example 3 of the presently filed embodiment;

FIG. 20 is a view, illustrating a charging and discharging curve of a battery obtained in Comparative Example 3 of the presently filed embodiment, wherein the abscissa designates a capacity and the ordinate designates a voltage V;

FIG. 21A is a view, illustrating an electrical characteristic of iron olivine studied in the presently filed embodiment, wherein the abscissa designates a charging and discharging capacity DC and the ordinate designates a discharging voltage DV;

FIG. 21B is a view, illustrating an electrical characteristic of graphite studied in the presently filed embodiment, wherein the abscissa designates a charging and discharging capacity DC and the ordinate designates a discharging voltage DV;

FIG. 21C is a view, illustrating an electrical characteristic of lithium titanate studied in the presently filed embodiment, wherein the abscissa designates a charging and discharging capacity DC and the ordinate designates a discharging voltage DV;

FIG. 21D is a view, illustrating an electrical characteristic of spinel manganese studied in the presently filed embodiment, wherein the abscissa designates a charging and discharging capacity DC and the ordinate designates a discharging voltage DV; and

FIG. 21E is a view, illustrating an electrical characteristic of hard carbon studied in the presently filed embodiment, wherein the abscissa designates a charging and discharging capacity DC and the ordinate designates a discharging voltage DV;

### BEST MODE FOR CARRYING OUT THE INVENTION

Hereinafter, a method of manufacturing a secondary battery electrode, a manufacturing apparatus for the same and a secondary battery electrode of an embodiment according to the present invention are described below in detail with suitable reference to the accompanying drawings.

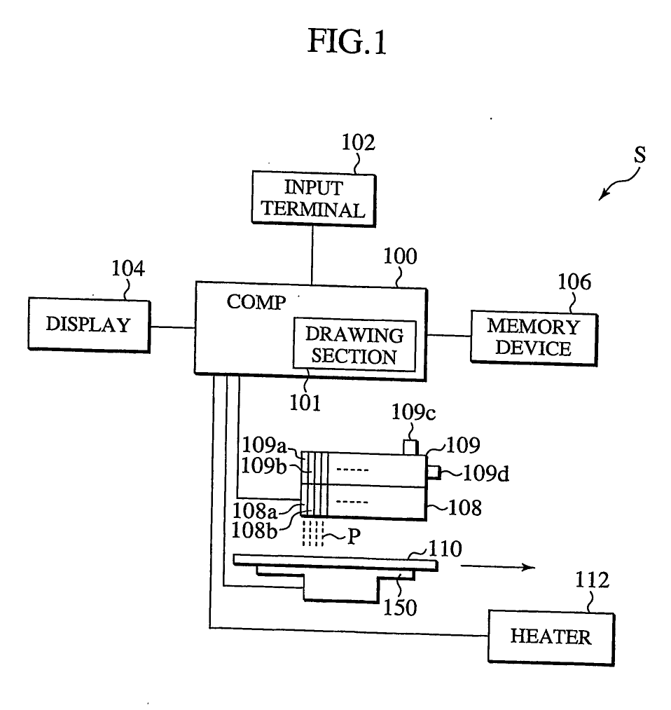

FIG. 1 is a block diagram illustrating a schematic structure of a manufacturing apparatus for a secondary battery electrode of an embodiment according to the present invention.

As shown in FIG. 1, the manufacturing apparatus S for the secondary battery electrode is comprised of a computer 100, an input terminal 102, a display 104, a memory device 106, injection nozzles 108 and a heater 112, all of which are connected to the computer 100, respectively. The heater 112 dries active materials deposited onto a current collector 110.

The computer 100 includes a drawing section 101 that draws a deposition pattern (pattern to be injected and deposited), based on information inputted from the input terminal 102, which is displayed over the display 104. Also, the computer 100 includes a processing unit, a memory and an input and output interfaces, all of which are not shown, and may include the input terminal 102, the display 104 and the memory device 106.

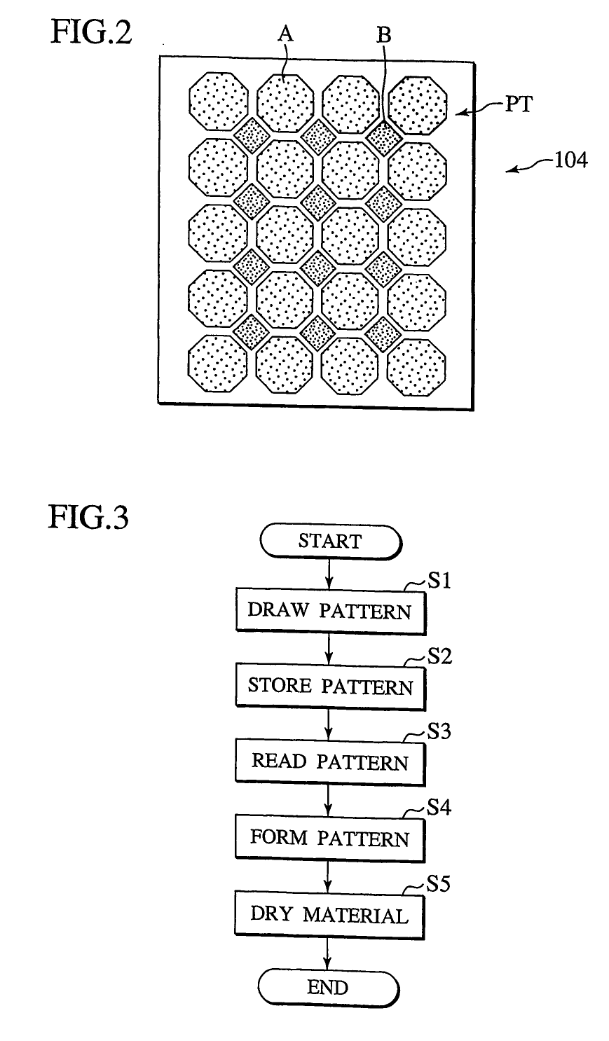

FIG. 2 is a view showing such a deposition pattern PT and, in this exemplary case, the deposition pattern PT includes a plurality of kinds of active materials indicated as two kinds of A and B. The deposition pattern serves as a pattern that is designed to allow respective inks of active materials A and B, different in electrical characteristic, to be injected and deposited onto discrete areas of the current collector. Here, by the electrical characteristic is meant the characteristic showing the relationship between the amount of charging and output voltage of a secondary battery formed by using such active materials.

In the deposition pattern, graphics different in shape (with active material A formed in an octagon shape and active material B formed in a quadrangular shape in FIG. 2) are separate from one another and regularly and periodically placed in position. The respective graphics are colored up and each color is allocated for each kind of active materials (with active material A assigned to black color, but shown in black points in a high density for the sake of convenience, and active material B assigned to yellow color but shown in black points in a low density for the sake of convenience in FIG. 2). Also, the deposition pattern to be designed in a particular layout is determined in view of charging and discharging characteristics (such as state of charge—output voltage characteristic) of the secondary battery to be finally obtained.

The input terminal 102 is used to input information based on which the deposition pattern is drawn in the computer 100. This information includes designation of a shape of each graphic, designation of a size of each graphic, designation of a layout area for each graphic and designation of a color of each graphic.

The display 104 provides a color display of the deposition pattern PT drawn by the computer 100 in a manner as shown in FIG. 2. An operator works up a desired deposition pattern while looking at this color display.

The memory device 106 serves to store the deposition pattern finally created by the computer 100.

The injection nozzles (ink jet) 108 serve to inject the inks of respective kinds of active materials onto the current collector 110 as multiple particles P in accordance with the deposition pattern stored in the memory device 106. Here, the injection nozzles are classified into various types such as a piezoelectric system, a thermal system and a bubble system. The piezoelectric system is of the type in which a piezoelectric element, located at a bottom of a chamber in which propellant formed of liquid is accumulated, responds to the flow of electric current to be deformed for thereby injecting propellant from a nozzle. The thermal system is of the type that includes a heater element to heat propellant to inject liquid with energy resulting from steam explosion initiated during evaporation of propellant. The bubble jet (trademark) type is of the type that inject liquid with energy of steam explosion occurring during evaporation of propellant in a manner similar to the thermal system. The thermal system and the bubble system are different in an area to be heated up but are identical on a fundamental theory. Also, it doesn't matter if an air stream or electrostatic force is combined in use during injection. Operation of the injection nozzles 108 is controlled with the computer 100.

Coupled to the injection nozzles 108 are propellant containers 109, respectively, which accommodate liquid propellant mixed with active materials. The propellant containers 109 are classified (as designated at 109a, 109b . . . ) for the respective kinds of active materials and are connected to dedicated injection nozzles 108 (108a, 108b . . . ) allocated to respective active materials. It can be said that the injection nozzles 108 are allocated to colors of the graphics drawn as the deposition pattern. Incidentally, the propellant containers 109 may include a stirring unit 109c for stirring propellant and a heater 109d for heating propellant if desired.

Thus, due to the presence of colors of the graphics, drawn on the deposition pattern, which is allocated to the kinds of active materials, the computer 100 drives different injection nozzles in dependence on colors of the graphics drawn on the deposition pattern.

A heater 112 is provided for drying active materials deposited on the current collector 110. An injection pattern similar to the deposition pattern is formed on the current collector 110 supported on a carrier 150 and after such a pattern is formed, the carrier 150 is moved to transfer the current collector 110 into a drying furnace (not shown) to be heated by the heater 112.

That is, with the structure of the presently filed embodiment, a secondary battery electrode with a desired electric characteristic is formed by an ink jet system. By the ink jet system is meant the printing system that includes nozzles from which liquid propellant (hereinafter referred to as ink) containing at least active materials is injected onto an object for deposition thereon. In order to form an electrode layer using the ink jet system, inks for forming the electrode layer are prepared. If a positive electrode layer is to be manufactured, a positive electrode ink containing ingredients of the positive electrode layer is adjusted. If a negative electrode layer is to be manufactured, a negative electrode ink containing ingredients of the negative electrode layer is adjusted. For example, the positive electrolyte ink may include at least positive electrode material. The positive electrolyte ink may also include conductive material, lithium salt and solvent. In order to improve ion conductivity of the positive electrode, the positive electrode ink may contain polymer electrolyte raw material forming polymer electrolyte upon polymerization and polymerization initiator agent.

Materials, such as current collector and active materials, for forming the secondary battery electrode are not particularly limited and various materials may be employed. In case where the secondary battery electrode takes the form of an electrode of a lithium battery, an example of positive electrode active material may include Li—Mn family composite oxides, such as LiMn₂O₄, and Li—Ni family composite oxides such as LiNiO₂. According to circumstances, positive electrode active materials of more than two kinds are combined in use. An example of negative electrode active material may include crystalline carbon and amorphous carbon material. In particular, these include natural graphite, artificial graphite, carbon black, active carbon, carbon fiber, cokes, soft carbon and hard carbon. According to circumstances, negative electrode active materials of more than two kinds are combined in use.

Also, a substrate on which the electrode layer is formed is prepared. The substrate may include component parts, such as a current collector and a polymer electrolyte membrane, adjacent to the electrode layer in the secondary battery. The current collector has a general thickness approximately equal to or greater than 5 μm and equal to or less than 20 μm. However, a current collector with a thickness out of such a range may be employed. And, the substrate is supplied to a device in which the printing is performed by the ink jet system, whereupon the inks are injected onto the substrate by the ink jet system for deposition thereto. The ink (droplets) can be injected from the nozzle of the ink jet in an extremely minor volume and at a substantially equal volume. Moreover, using the ink jet system allows the thickness and shape of the electrode layer to be precisely controlled.

In case where the electrode layer is formed using a coating machine such as a general coater, it is hard to form the electrode layer in a complicated shape. On the contrary, the use of the ink jet system allows the electrode layer with a desired electrical characteristic to be formed merely by letting the computer design a given injection pattern and simply printing the resulting injection pattern. With respect to the thickness, in case where shortage occurs in the thickness of the electrode layer through a single step of printing, the printing may be repeatedly carried out onto the substrate more than two times. That is, the same ink is injected onto the same substrate in a superposed manner. This allows the formation of the electrode layer with a given thickness.

The thickness of the electrode layer is not particularly limited. In general, the positive electrode layer has a thickness approximately equal to or greater than 1 μm and equal to or less than 100 μm, and the negative electrode layer has a thickness approximately equal to or greater than 1 μm and equal to or less than 140 μm.

Using the ink jet system makes it possible to form the secondary battery electrode of the presently filed embodiment, but no particular limitation is intended to such a system. As described in conjunction with Examples described latter, a desired specification may be suitably determined in accordance with the ink to be used.

To manufacture a secondary battery electrode using a method of the presently filed embodiment, first, a substrate to be formed with an electrode layer through the use of the ink jet system is prepared. As the substrate, a current collector or a polymer electrolyte membrane is used. In case where it is hard to supply the substrate, by itself, to the ink jet device, the substrate may suffice to be attached to a medium such as a sheet of paper and then supplied to the ink jet device.

Prior to carrying out the printing through the use of the ink jet system, the positive electrode ink and negative electrode ink are prepared. In case where a polymer electrolyte membrane is also fabricated using the ink jet system, an electrolyte ink is also prepared.

Ingredients, to be contained in the positive electrode ink, may include positive electrode active material, conductive material, polymer electrolyte raw material, lithium salt, polymerization initiator agent and solvent. Also, at least positive electrode active material may also be included as ingredient. A sample of positive electrode active material may include olivine with a discharging average voltage of 3.5 V, manganese spinel with a discharging average voltage of 3.9 V, cobalt with a discharging average voltage of 3.8 V and nickel with a discharging average voltage of 3.7 V. Polymer electrolyte raw material, such as macromer between ethylene oxide and propylene oxide, and polymerization initiator agent, such as benzyldimethyl-ketal, may be formulated to form the positive electrode ink with which the positive electrode layer is printed on the current collector and polymerization is initiated thereby improving an ion conductivity of the electrode layer. These ingredients are mixed in solvent and sufficiently stirred. Solvent is not particularly limited and may include acetonitrile.

The blending ratio of ingredients to the positive electrode ink is not particularly limited. However, the positive electrode ink should be low in viscosity to the extent that the ink jet system can be employed. The viscosity is maintained at a lower level in various methods including step of increasing the blending quantity of solvent and step of raising the temperature of positive electrode ink. However, if the blending quantity of solvent increases too much, the amount of active material per unit volume in the electrolyte layer decreases and, hence, the blending quantity of solvent may be preferably limited to a minimal value. In alternative, polymer electrolyte raw material and other compounds may be adjusted so as to decrease the viscosity.

Ingredients, to be contained in the negative electrode ink, may include negative electrode active material, conductive material, polymer electrolyte raw material, lithium salt, polymerization initiator agent and solvent. Also, at least negative electrode active material is also included as constituent. A sample of negative electrode active material may include hard carbon, graphite, titanium and alloy of these components. Polymer electrolyte raw material, such as macromer between ethylene oxide and propylene oxide, and polymerization initiator agent, such as benzyldimethyl-ketal, may be formulated to form the negative electrode ink with which the negative electrode layer is printed on the current collector and polymerization is initiated thereby improving an ion conductivity of the electrode layer. These ingredients are mixed in solvent and sufficiently stirred. Solvent is not particularly limited and may include acetonitrile.

The blending ratio of ingredients to the negative electrode ink is not particularly limited. The explanation of the blending ratio is in the same manner as that of positive electrode ink.

Ingredients, to be contained in the electrolyte ink, may include polymer electrolyte raw material, lithium salt, polymerization initiator agent and solvent. Also, at least polymer electrolyte raw material is also included as ingredient. Polymer electrolyte raw material is not particularly limited provided that raw material includes compound to form a polymer electrolyte layer upon polymerization subsequent to step of executing ink jet. Such an example may include macromer between ethylene oxide and propylene oxide. These ingredients are mixed in solvent and sufficiently stirred. Solvent is not particularly limited and may include acetonitrile.

The blending ratio of ingredients to the electrolyte ink is not particularly limited. The explanation of the blending ratio is in the same manner as that of positive electrode ink. In the electrolyte ink, polymer electrolyte raw material is included relatively in large quantity and thus it is to be considered that such polymer electrolyte raw material tends to increase the viscosity of the electrolyte ink. Incidentally, it is needless to say that the electrolyte ink is not required when the electrolyte itself of the battery to be produced is liquid.

The viscosities of the respective inks to be supplied to the injection nozzles 108 are not particularly limited and may preferably lie at a value approximately equal to or greater than 1 cP and equal to or less than 100 cP.

The volume of each particle (droplet) to be injected from each injection nozzle 108 may preferably lie at a value approximately equal to or greater than 1 pL and equal to or less than 100 pL. The volumes of particles to be injected using the ink jet device are substantially equalized and, so, the resulting electrode and the battery have an extremely high degree of uniformity.

If a film thickness of the electrode layer, obtained by merely depositing the particles from the injection nozzles 108 one time, is insufficient, the particles may be deposited on the same area more than two times to increase the thickness of the electrode layer. By the “same area” is meant the same position as that of the current collector onto which the particles are previously deposited by the ink jet device. That is, this means that the same material is recoated. Using such a technique to laminate the electrode layer several times in a uniform thickness allows the electrode to be formed in an increased thickness. In case where the electrode layer is formed by the ink jet device, since the resulting electrode layer has an extremely high degree of uniformity, such a high degree of uniformity can be maintained even if laminating steps are carried out several times.

After the electrode layer is formed, then, the electrolyte layer is dried to remove solvent. If solvent is blended with polymer electrolyte raw material, polymerizing step may be conducted to form a polymer electrolyte through polymerization. In case where photochemical polymerization initiator agent is added, ultraviolet ray is irradiated to initiate polymerization. This completes the formation of the electrode layer.

A process to which the manufacturing method of the presently filed embodiment is applied depends on a battery to be finally manufactured. In case where liquid electrolyte is intervened between a positive electrode and a negative electrode to form an integrated body that is sealed within an outer sheath for thereby completing a lithium ion battery, the positive electrode and the negative electrode are manufactured in accordance with the presently filed embodiment, and using these component parts enables assembling of a secondary battery. When manufacturing a whole solid bipolar battery, a positive electrode layer, a polymer electrolyte layer and a negative electrode layer are sequentially fabricated on a current collector, serving as a substrate, by the ink jet system, whereupon a current collector is laminated. If desired, repeatedly executing this work allows the whole solid bipolar battery, laminated even in several layers, to be completed. In this case, to fabricate the positive electrode layer, the polymer electrolyte membrane and the negative electrode layer, the manufacturing method of the presently filed embodiment is used.

Incidentally, in order to provide an improved productivity on an industrial production process, it may be possible to take step for manufacturing the electrode in a size greater than that of a battery to be finally obtained and cutting the resulting electrode in a given size.

FIG. 3 is a flowchart illustrating a sequence of a method of manufacturing a secondary battery electrode, of the presently filed embodiment, which is described in a sequence described below.

As shown in FIG. 3, first, in step S1, the operator operates the input terminal 102 to input information necessary for drawing the deposition pattern PT as shown in FIG. 2. The drawing section 101 of the computer 100 draws the deposition pattern based on information that is inputted, and the resulting deposition pattern is displayed over the display 104. Accordingly, the operator inputs necessary information through the input terminal 102, while looking at the deposition pattern on the display 104, as if he draws a picture, and a desired deposition pattern is produced.

In next step S2, the computer 100 stores the resulting deposition pattern PT into the memory device 106.

In succeeding step S3, when manufacturing the secondary battery electrode, the computer 100 accesses the memory device 106 to read the deposition pattern PT stored in the memory device 106.

In subsequent step S4, the computer 100 individually controls operations of the plural injection nozzles 108 in accordance with the deposition pattern PT, which is read in, to allow active materials of respective kinds depending upon the deposition pattern PT to be injected as multiple particles onto the current collector 110 to be deposited thereon. Such an injection pattern corresponds to the deposition pattern PT shown in FIG. 2 and includes a pattern that is designed in a way to allow respective active materials with different electrical characteristics to be regularly and periodically located On the discrete areas on the current collector 110 in an individual fashion.

Here, each of the propellant containers 109 accommodates therein liquid, containing active material of the kind to be injected onto the current collector 110, whose viscosity is adjusted. Each of the propellant containers 109 is provided for each kind of active material, and the propellant containers 109 are connected to the injection nozzles 108, respectively. Consequently, for example, the computer 100 drives the injection nozzles 108a such that when intended to inject active material A described in black color in the deposition pattern in FIG. 2, it injects active material A and drives the injection nozzles 108b such that when intended to inject active material B described in yellow color in the deposition pattern, it injects active material B. If active material is injected one by one line as if a commonly available printer draws, the injection nozzles 108 and the current collector 110 need to be moved relative to one another when the injection is carried out. However, with the presently filed embodiment, since the multiple injection nozzles 108a, 108b are disposed above the surface of the current collector to enable active materials to be injected, no need arises for moving the injection nozzles 108 and the current collector 110 relative to one another. Also, the thickness of the layer to be formed is adjusted by selecting the number of times that the identical injection pattern is overprinted.

And, finally, in step S5, to dry active material deposited on the current collector 110, the current collector 110 is transferred to the draying furnace, whereupon heating is conducted using the heater 112 disposed within the drying furnace.

Incidentally, in case where the secondary battery electrode includes a bipolar electrode, since a need arises for forming the positive electrode on one surface of the current collector 110 and the negative electrode on the other surface thereof, the sequence described above is executed two times; one for forming the positive electrode layer and the other for forming the negative electrode. When this takes place, the injection pattern for the positive electrode and the injection pattern for the negative electrode are different from one another. As a matter of course, the kind of active material to be injected for forming the positive electrode layer differs from the kind of active material to be injected for forming the negative electrode layer.

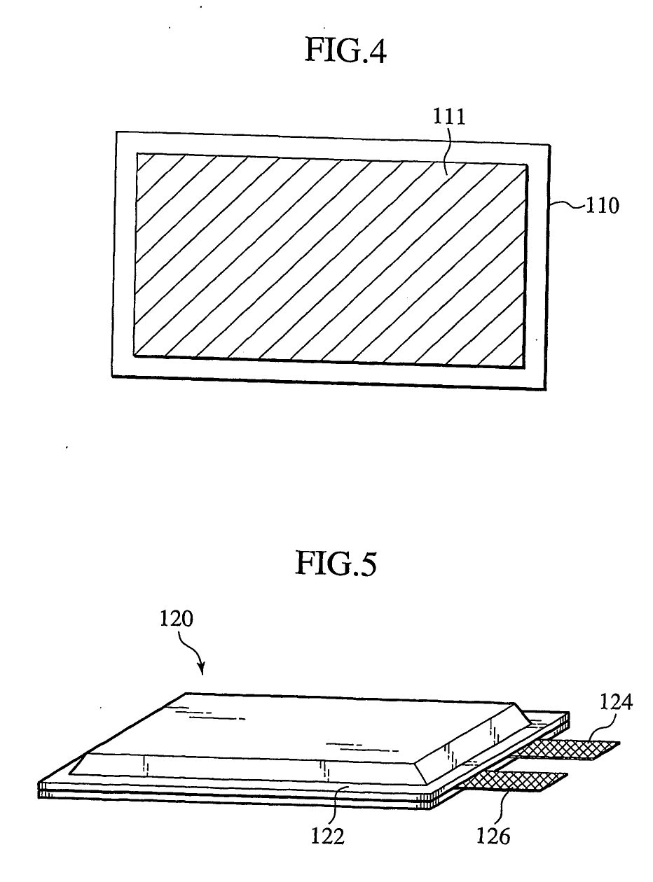

FIG. 4 is a top view of the secondary battery electrode (bipolar electrode) that is formed on the sequence set forth above.

As shown in FIG. 4, a planar area (hatched area) with one size smaller than the current collector 110 is formed with an electrode layer (active material layer) 111 drawn with active material in the injection pattern shown in FIG. 2. Accordingly, in a detail view, the electrode layer 111 results in a structure wherein the respective graphics, formed of active materials with different electrical characteristics, are regularly and periodically located in the discrete areas of the current collectors 110 in a separate manner.

Here, in case of the bipolar electrode, the current collector 110 has the both surfaces formed with the electrolyte layers and, if the electrode layer 111 of FIG. 4 is the positive electrode, the negative electrode layer is formed on the opposite surface. With the secondary battery electrode of the presently filed embodiment, since the electrode layer is formed in a pattern wherein active materials of different kinds are scattered in the respective areas, it becomes possible to easily form the secondary battery in a desired electrical characteristic (the relationship between the amount of charging and output voltage) depending upon the ratio of the active materials to be scattered respectively.

FIG. 5 is a perspective view of a secondary battery incorporating the secondary battery electrode of the presently filed embodiment.

As shown in FIG. 5, the secondary battery 120 internally accommodates a battery element and the battery element is comprised of a plurality of the secondary battery electrodes (bipolar electrodes) that are alternately laminated intervening electrolytes. The battery element is sealed gas-tight with a polymer-metal composite laminate film 122. Connected to the battery element are a positive electrode terminal 124 and a negative electrode terminal 126, which in turn are extracted to the outside from the laminate film 122.

Connecting a plurality of secondary batteries of the presently filed embodiments in series, in parallel or in combination of series and parallel may form a battery unit.

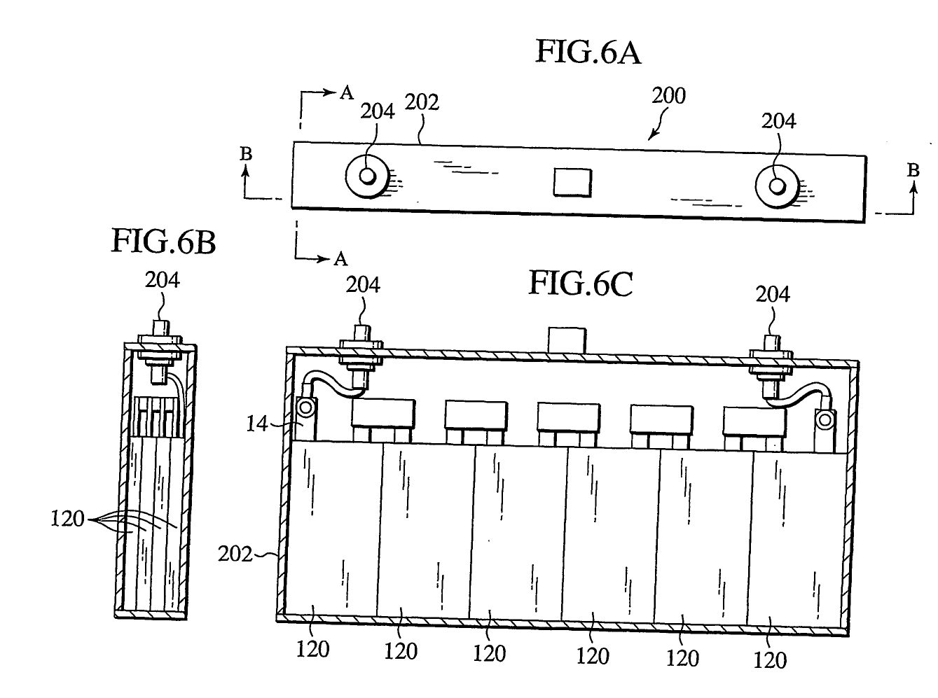

FIG. 6A is a plan view of the battery unit; FIG. 6B is a cross sectional view taken on line A-A of FIG. 6A; and FIG. 6C is a cross sectional view taken on line B-B of FIG. 6A.

As shown in FIGS. 6A to 6C, the battery unit 200 is disposed in an outer sheath casing 202. Inside of the outer sheath casing 202, the plurality of secondary batteries 120 of the presently filed embodiments are connected in series, in parallel or in combination of series and parallel. Extracted from the outer sheath casing 202 are terminals 204, of the positive electrodes or the negative electrodes of all the secondary batteries 120, which are used for connection to other devices.

The battery units 200 may be further connected in series, in parallel or in combination with series and parallel to form a combined battery.

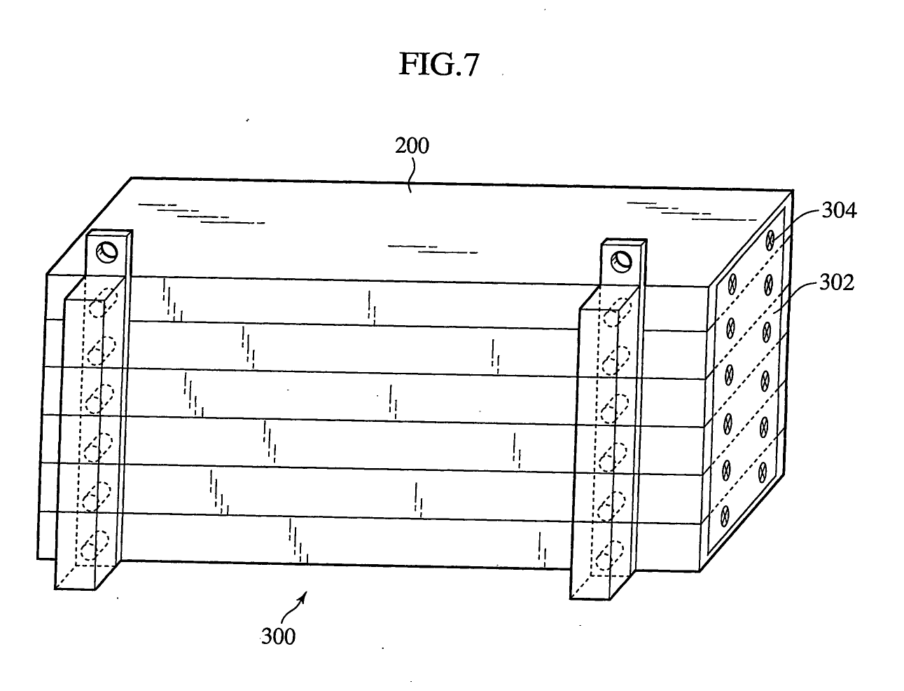

FIG. 7 is a perspective view of such a combined battery 300.

As shown in FIG. 7, the combined battery 300 is formed of the battery units 200 that are connected in series or in parallel and fixedly secured using a connecting plate 302 and connecting screws 304. Also, disposed in spaces and on the lowermost surface are external resilient bodies that alleviate impacts applied from the outside.

The number of and the way of connection of the secondary batteries 120 forming the battery units 200 and the combined battery 300 are determined in accordance with output and capacity required for the battery. When forming the battery unit or the combined battery, the battery has a more increased stability than that of the unit cells. Also, forming the battery unit or the combined battery enables the battery as a whole to be reduced from adverse affect resulting from deterioration of one unit cell.

The battery unit or the combined battery is able to be used for a vehicle.

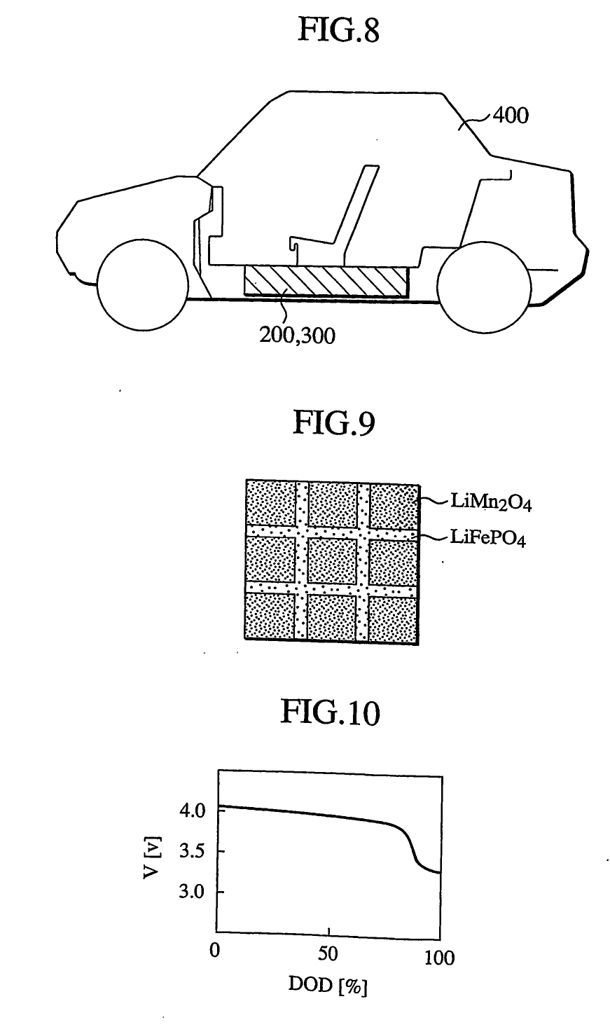

FIG. 8 is a side typical view of the vehicle 400 that is installed with the battery unit 200 or the combined battery 300.

As shown in FIG. 8, the battery unit 200 or the combined battery 300 installed on the vehicle 400 has an electrical characteristic as a power supply matched to a power performance and a running performance of the vehicle. For this reason, the vehicle, on which the secondary battery 120, the battery unit 200 or the combined battery 300 is installed, has a high durability and is able to provide sufficient output even after use for a long period. Further, such batteries have a high durability with respect to vibrations and even when used in an environment, such as in the vehicle, in which the batteries are applied with vibrations at all times, deterioration hardly occurs in the battery due to resonance.

Further, the presence of the batteries formed in a small size provides a remarkable advantage particularly when applied to the vehicle. Suppose that the bipolar battery, with both the electrodes and polymer electrolyte being manufactured by the ink jet system, is formed. When this takes place, suppose that the current collector has a thickness of 5 μm, the solid electrolyte layer has a thickness of 5 μm, the negative electrode layer has a thickness of 5 μm and one battery element has a thickness of 20 μm. Suppose that one hundred layers of such bipolar batteries are stacked to provide a bipolar battery with output of 420 V, the presence of the battery with a volume of 0.5 L provides output of 25 kW and 70 Wh. In theory, the resulting battery with a value less than one tenth in size of a general battery enables the extraction of equivalent output.

### EXAMPLE

Hereinafter, the presently filed embodiment according to the present invention is described more in detail with reference to Examples. In these Examples, unless otherwise indicated, as polymer electrolyte raw material, lithium salt, positive electrode active material and negative electrode active material employed materials, the following materials were used.

That is, the polymer electrolyte raw material includes macromer between ethylene oxide (EO) and propylene oxide (PO) synthesized based on a method disclosed in Japanese Patent Application Laid-Open Publication 2002-110239. Photochemical polymerization initiator agent includes bezyldimethyl-ketal. Lithium salt includes LiN(SO₂C₂F₅)₂ (hereinafter referred to as “BETI”). Positive electrode material includes spinel type LiMn₂O₄ (with mean particle diameter (size): 0.6 μm). Negative electrode active material includes pulverized graphite (with mean particle diameter: 0.7 μm).

Further, adjustment and printing of negative electrode ink, positive electrode ink ad electrolyte ink and assembling of a battery were carried out in a dried atmosphere at a temperature below the dew point of −30° C.

### Example 1

In this Example, in a manner described below, two kinds of positive electrode inks were prepared which in order to form a positive electrode layer, included a positive electrode ink, using iron olivine, and a positive electrode ink using spinel manganese, and a negative electrode ink using graphite was prepared in order to form a negative electrode layer. The positive electrode layer and the negative electrode layer were formed based on a deposition pattern that was prepared by using a computer.

<Adjustment of Positive Electrode Ink>

Iron Olivine Ink

Iron olivine (LiFePO₄) with a mean particle diameter of 0.5 μm (in 37% by weight), acetylene black (in 15% by weight) serving as conductive material, polymer electrolyte raw material (in 32% by weight), BETI (in 16% by weight) and bezyldimethyl-ketal serving as photochemical polymerization initiator agent (0.1% by weight in terms of polymer electrolyte raw material) were added and sufficiently stirred, thereby adjusting slurry. The resulting ink had a viscosity of approximately 300 cP. Also, the viscosity at a temperature of 60° C. was 30 cP. In the presence of the ink with an insufficient viscosity, the heater mounted to the propellant container 109 described above is used to heat the ink to suitably adjust the viscosity. Since the iron olivine has a low electrical conductivity, a lot of conductive materials are needed and further, due to the presence of a large specific surface area, a large amount of binder is required.

Spinel Manganese Ink

Lithium manganese (LiMn₂O₄) with a mean particle diameter of 0.6 μm (in 47% by weight), acetylene black (in 13% by weight) serving as conductive material, polymer electrolyte raw material (in 27% by weight), BETI (in 13% by weight) and bezyldimethyl-ketal serving as photochemical polymerization initiator agent (0.1% by weight in terms of polymer electrolyte raw material) were added and sufficiently stirred, thereby adjusting slurry. The resulting ink had a viscosity of approximately 200 cP. Also, the viscosity at a temperature of 60° C. was 20 cP.

<Adjustment of Negative Electrode Ink>

Graphite Ink

Graphite with a mean particle diameter of 0.7 μm (in 60% by weight), polymer electrolyte raw material (in 27% by weight), BETI (in 13% by weight) and bezyldimethyl-ketal serving as photochemical polymerization initiator agent (0.1% by weight in terms of polymer electrolyte raw material) were added and sufficiently stirred, thereby adjusting slurry. The resulting ink had a viscosity of approximately 200 cP. Also, the viscosity at a temperature of 60° C. was 20 cP.

<Fabrication of Battery>

Using the adjusted ink and a commercially available piezoelectric type ink jet printer (represented by the nozzles 108 and the containers 109 in FIG. 1), an electrode layer was formed in a sequence described below. Incidentally, due to a fear in that the above ink resulted in a low viscosity to cause the precipitation of active material, the stirring unit (rotary vane) 109c was rotated to stir the ink of the ink pool in the container 109 at all times.

The ink jet printer was controlled using a commercially available computer and associated software for operating the same. More particularly, when preparing the positive electrode layer, the positive electrode inks of the above two kinds that were adjusted were used, and using the ink jet printer achieved the printing of the injection pattern, as shown in FIG. 9, which was prepared on the computer. In this injection pattern, a coating surface area was designed such that the ratio of spinel manganese to iron olivine was 9:1 in volume. Also, because of a difficulty in supplying a metal foil directly into the printer, the metal foil was attached onto a sheet of woodfree paper with a size of A4, which in turn was fed to the printer by which the printing was carried out.

The positive electrode ink was introduced into the ink jet printer, and the deposition pattern prepared on the computer was printed on an aluminum foil with a thickness of 20 μm serving as a current collector. The volume of particles of the positive electrode ink, injected from the ink jet printer, was approximately 2 pL. The positive electrode ink was printed on the same surface five times, thereby forming a positive electrode layer.

After printing, in order to dry out solvent, the resulting current collector was dried in an evacuated oven (dryer furnace) at a temperature of 60° C. for two hours. After drying, in order to polymerize the polymer electrolyte raw material, an ultraviolet ray was irradiated onto the current collector in an evacuated condition for twenty minutes, thereby laminating the positive electrode layer on the current collector.

Next, the negative electrode ink was introduced into the ink jet printer, and the deposition pattern specified only for an injection area prepared on the computer was printed on the other surface of the aluminum foil whose one surface was already formed with the positive electrode layer. The volume of particles of the negative electrode ink, injected from the ink jet printer, was approximately 2 pL. The negative electrode ink was printed on the same surface five times, thereby forming a negative electrode layer. After forming the electrode layers on both surface of the current collector, the current collector was cut into a given battery size.

After printing, in order to dry out solvent, the resulting current collector was dried in the evacuated oven (dryer furnace) at the temperature of 60° C. for two hours. After drying, in order to polymerize the polymer electrolyte raw material, the ultraviolet ray was irradiated onto the current collector in the evacuated condition for twenty minutes, thereby laminating the negative electrode layer on the current collector.

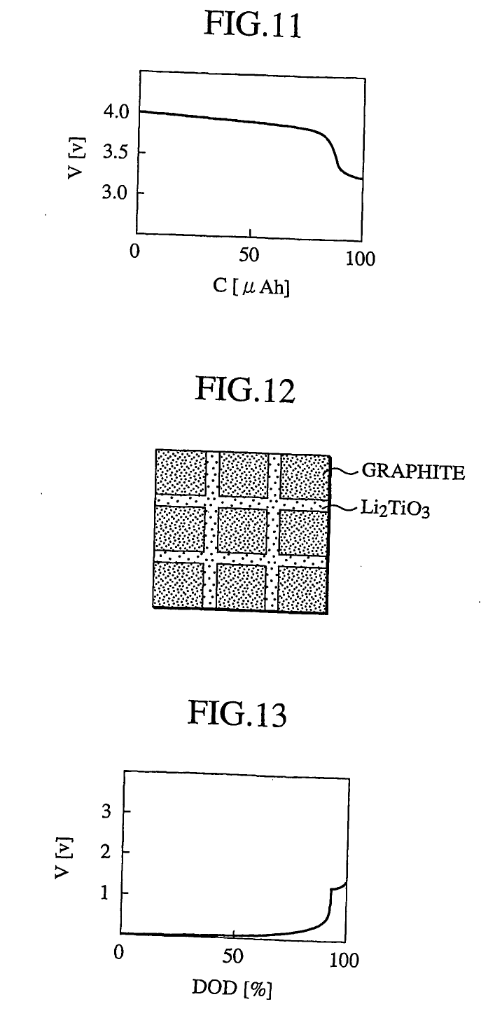

The positive electrode manufactured in such a way discussed above demonstrated a charging and discharging curve as shown in FIG. 10. Further, the battery using graphite as the negative electrode demonstrated a charging and discharging curve as shown in FIG. 11. Both the charging and discharging curves included curves wherein as the discharging proceeded to some extent, the voltage rapidly dropped.

### Example 2

In this Example, in a manner described below, a positive electrode ink using spinet manganese was prepared in order to form a positive electrode layer, and in order to form a negative electrode layer, two kinds of negative electrode inks were prepared which included an ink using graphite and an ink using lithium titanate. A positive electrode layer and a negative electrode layer were formed based on a deposition pattern prepared by using a computer. Incidentally, the positive electrode ink using spinet manganese was adjusted in the same way as that of Example 1.

<Adjustment of Negative Electrode Ink>

Graphite Ink

The negative electrode ink using graphite was adjusted in the same way as that of Example 1.

Lithium Titanate Ink

Lithium titanate (Li₄Ti₅O₁₂) with a mean particle diameter of 0.5 μm (in 37% by weight), acetylene black (in 15% by weight) serving as conductive material, polymer electrolyte raw material (in 32% by weight), BETI (in 16% by weight) and bezyldimethyl-ketal serving as photochemical polymerization initiator agent (0.1% by weight in terms of polymer electrolyte raw material) were added and sufficiently stirred, thereby adjusting slurry. The resulting ink had a viscosity of approximately 300 cP. Also, the viscosity at a temperature of 60° C. was 30 cP.

<Fabrication of Battery>

Like in Example 1, using the adjusted ink and the commercially available piezoelectric type ink jet printer, an electrode layer was formed in a sequence described below. Incidentally, due to a fear in that the above ink resulted in a low viscosity to cause the precipitation of active material, the stirring unit (rotary vane) 109c was rotated to stir the ink of the ink pool in the container 109 at all times.

The ink jet printer was controlled using the commercially available computer and associated software for operating the same. More particularly, when preparing the negative electrode layer, the negative electrode inks of the above two kinds that were adjusted were used. A negative electrode layer was fabricated by printing the deposition pattern shown in FIG. 12, which was prepared on the computer upon, using the ink jet printer. In this deposition pattern, a coating surface area was designed such that the ratio of graphite to lithium titanate was 9:1 in volume. Incidentally, because of a difficulty in supplying a metal foil directly into the printer, the metal foil was attached onto a sheet of woodfree paper with a size of A4, which in turn was fed to the printer by which the printing was carried out.

The negative electrode ink was introduced into the ink jet printer, and the deposition pattern prepared on the computer was printed on an aluminum foil with a thickness of 20 μm serving as a current collector. The volume of particles of the positive electrode ink, injected from the ink jet printer, was approximately 2 pL. The negative electrode ink was printed on the same surface five times, thereby forming a negative electrode layer.

After printing, in order to dry out solvent, the resulting current collector was dried in the evacuated oven (dryer furnace) at the temperature of 60° C. for two hours. After drying, in order to polymerize the polymer electrolyte raw material, the ultraviolet ray was irradiated onto the current collector in the evacuated condition for twenty minutes, thereby laminating the positive electrode layer on the current collector.

Next, the positive electrode ink was introduced into the ink jet printer, and the deposition pattern specified only for an injection area prepared on the computer was printed on the other surface of the aluminum foil whose one surface was already formed with the negative electrode layer. The volume of particles of the negative electrode ink, injected from the ink jet printer, was approximately 2 pL. The positive electrode ink was printed on the same surface five times, thereby forming a positive electrode layer. After forming the electrode layers on both surface of the current collector, the current collector was cut into a given battery size.

After printing, in order to dry out solvent, the resulting current collector was dried in the evacuated oven (dryer furnace) at the temperature of 60° C. for two hours. After drying, in order to polymerize the polymer electrolyte raw material, the ultraviolet ray was irradiated onto the current collector in the evacuated condition for twenty minutes, thereby laminating the positive electrode layer on the current collector.

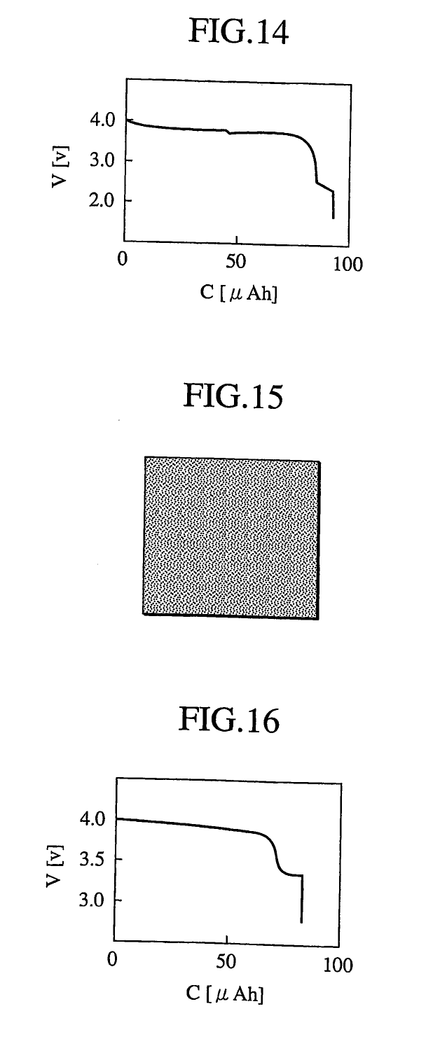

The negative electrode manufactured in such a way discussed above demonstrated a charging and discharging curve, as shown in FIG. 13, in that as the discharging proceeded to some extent, the voltage rapidly raised. Also, the battery using spinet manganese as the positive electrode demonstrated a charging and discharging curve, as shown in FIG. 14, in that as the discharging proceeded to some extent, the voltage rapidly raised.

### Comparative Example 1

In this Comparative Example, no step of injecting the two kinds of positive electrode inks, one of which included iron olivine and the other of which included spinet manganese, onto the discrete areas to form the electrode layer in accordance with the deposition pattern, like in Example 1, but a so-called solid spraying was carried out by uniformly injecting a mixed ink of iron olivine and spinel manganese merely over an entire injection area to form an electrode layer. The positive electrode ink and the negative electrode ink were adjusted in a manner described below.

<Adjustment of Positive Electrode Ink>

Mixed Ink with Iron Olivine Ink and Spinel Manganese

The positive electrode ink was adjusted under a condition in conformity to iron olivine that is low in conductivity and large in specific surface area.

Iron olivine (LiFePO₄) (in 3% by weight) with a mean particle diameter of 0.5 μm and lithium manganese (LiMn₂O₄) (in 34% by weight) with a mean particle diameter of 0.6 μm were mixed, whereupon acetylene black (in 15% by weight) serving as conductive material, polymer electrolyte raw material (in 32% by weight), BETI (in 16% by weight) and bezyldimethyl-ketal serving as photochemical polymerization initiator agent (0.1% by weight in terms of polymer electrolyte raw material) were added and sufficiently stirred, thereby adjusting slurry. The resulting ink had a viscosity of approximately 300 cP. Also, the viscosity at the temperature of 60° C. was 30 cP.

<Adjustment of Negative Electrode Ink>

Graphite Ink

The negative electrode ink using graphite was adjusted in the same manner as that of Example 1.

<Fabrication of Battery>

Like in Examples 1 and 2, electrode layers were formed by using the adjusted ink and the commercially available piezoelectric type ink jet printer.

The ink jet printer was controlled using the commercially available computer and associated software for operating the same. The positive electrode was fabricated using the ink jet printer to print the deposition pattern (in merely solid spraying), shown in FIG. 15, specified only for an injection area that was prepared on the computer.

The positive electrode ink was introduced into the ink jet printer, and the deposition pattern prepared on the computer was printed on an aluminum foil with a thickness of 20 μm serving as a current collector. The volume of particles of the positive electrode ink, injected from the ink jet printer, was approximately 2 pL. The positive electrode ink was printed on the same surface five times, thereby forming a positive electrode layer.

After printing, in order to dry out solvent, the resulting current collector was dried in the evacuated oven (dryer furnace) at the temperature of 60° C. for two hours. After drying, in order to polymerize the polymer electrolyte raw material, the ultraviolet ray was irradiated onto the current collector in the evacuated condition for twenty minutes, thereby laminating a positive electrode layer on the current collector.

Next, the negative electrode ink was introduced into the ink jet printer, and the deposition pattern specified only for the injection area prepared on the computer was printed on the other surface of the aluminum foil whose one surface was already formed with the positive electrode layer. The volume of particles of the negative electrode ink, injected from the ink jet printer, was approximately 2 pL. The negative electrode ink was printed on the same surface five times, thereby forming a negative electrode layer. After forming the electrode layers on both surface of the current collector, the current collector was cut into a given battery size.

After printing, in order to dry out solvent, the resulting current collector was dried in the evacuated oven (dryer furnace) at the temperature of 60° C. for two hours. After drying, in order to polymerize the polymer electrolyte raw material, the ultraviolet ray was irradiated onto the current collector in the evacuated condition for twenty minutes, thereby laminating the negative electrode layer on the current collector.

The positive electrode manufactured in such a way discussed above demonstrated a charging and discharging curve, as shown in FIG. 16, wherein as the discharging proceeded to some extent, the voltage rapidly dropped.

### Comparative Example 2

In this Comparative Example, instead of spraying the two kinds of inks, that is, the ink graphite and the other ink including lithium titanate, over the discrete areas in accordance with the deposition pattern, like in Example 2, the mixed ink with graphite and lithium titanate was injected by so-called solid spraying to form an electrode layer. The positive electrode ink and the negative electrode ink were adjusted in a manner described below.

<Adjustment of Positive Electrode Ink>

Spinel Manganese Ink

The positive electrode ink using spinel manganese was adjusted in the same manner as that of Example 1.

<Adjustment of Negative Electrode Ink>

Mixed Ink with Graphite and Lithium Titanate

Graphite with a mean particle diameter of 0.7 μm (in 29% by weight) and lithium titanate (Li₄Ti₅O₁₂) with a mean particle diameter of 0.6 μm (in 8% by weight) were mixed, whereupon acetylene black (in 15% by weight) serving as conductive material, polymer electrolyte raw material (in 32% by weight), BETI (in 16% by weight) and bezyldimethyl-ketal serving as photochemical polymerization initiator agent (0.1% by weight in terms of polymer electrolyte raw material) were added and sufficiently stirred, thereby adjusting slurry. The resulting ink had a viscosity of approximately 300 cP. Also, the viscosity at a temperature of 60° C. was 30 cP.

<Fabrication of Battery>

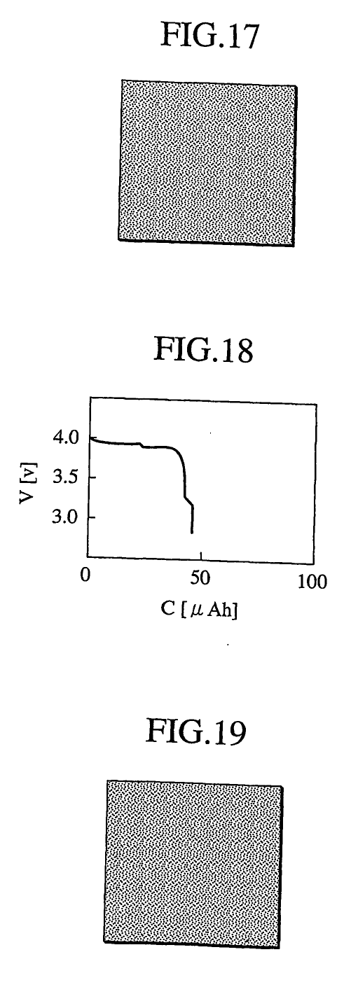

The positive electrode was fabricated using the ink jet printer by printing the deposition pattern (in the so-called solid-spraying) shown in FIG. 17, specified only for the injection area prepared on the computer, on the aluminum foil whose one surface was formed with the positive electrode layer. The battery was fabricated completely in the same manner as Comparative Example 1. The resulting battery demonstrated a charging and discharging curve, as shown in FIG. 18, wherein as the discharging proceeded to some extent, the voltage rapidly raised.

### Comparative Example 3

In this Comparative Example, no step of mixing the two kinds of inks different in electrical characteristic, like in Comparative Examples 1 and 2, was carried out, and the positive electrode layer was formed by spraying spinel manganese ink in the so-called solid-spraying while the negative electrode layer was formed by printing with graphite ink also in the so-called solid-spraying.

<Adjustment of Positive Electrode Ink>

Spinet Manganese Ink

The positive electrode ink using spinet manganese was adjusted in the same manner as that of Example 1.

<Adjustment of Negative Electrode Ink>

Graphite Ink

The negative electrode ink using graphite was adjusted in the same manner as that of Example 1.

<Fabrication of Battery>

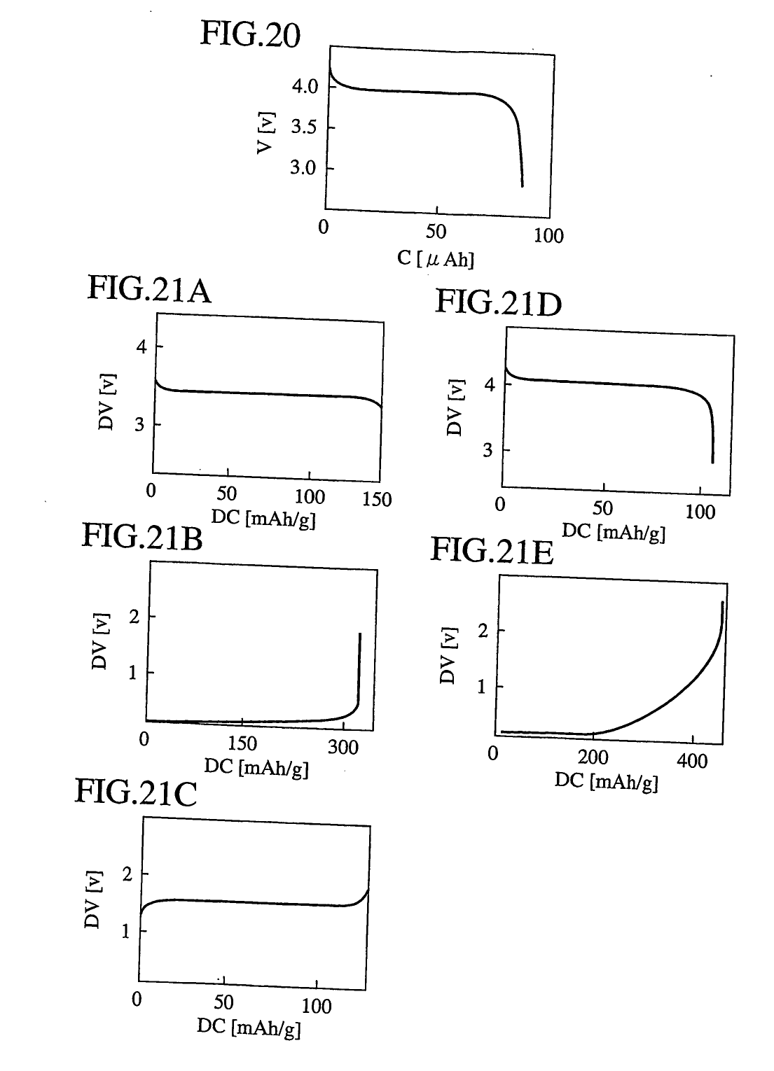

The positive electrode was fabricated using the ink jet printer by printing the deposition pattern, shown in FIG. 19, specified only for an injection area prepared. The resulting battery demonstrated a charging and discharging curve, as shown in FIG. 18, wherein as the discharging proceeded to some extent, the voltage rapidly raised. The negative electrode was fabricated using the ink jet printer by printing the deposition pattern, specified only for an injection area prepared on the computer, on the other surface of the aluminum foil whose one surface was formed with the positive electrode. A battery was fabricated completely in the same manner as Comparative Example 1. The resulting battery demonstrated a charging and discharging curve as shown in FIG. 20.

(Study and Evaluation)

Iron olivine, graphite, lithium titanate, spinet manganese and hard carbon used for the positive electrode ink and negative electrode ink solely describe charging and discharging curves shown in FIGS. 21A to 21E, respectively. Accordingly, by depositing these materials with inherent electrical characteristics onto the current collector in a given pattern, a battery can be created with the intension of providing a given electrical characteristic.

As shown in FIG. 10, the discharging curve of the battery manufactured in Example 1 results in the curve profiled in a two stage having both a pattern resulting from spinel manganese with the voltage of approximately equal to or more than 3.5 V and a pattern resulting from olivine iron with the voltage in the vicinity of 3.4 V. With the battery having such a curve with the two stage feature, the occurrence of rapid change in output voltage at a certain portion of the state of charge of the battery provides an ease of detecting the state of charge of the battery to provide no need for preparing a voltage detection circuit, which is extremely high in cost to be able to detect even a small voltage variation.

Further, with Example 1, the capacity of iron olivine was set to lie at 10% of a total volume and this value can be freely determined by changing the deposition pattern to be prepared. Incidentally, the battery of Example 1 had a discharging capacity of approximately 100 μAh.

On the contrary, although the battery manufactured in Comparative Example 1 by simply mixing active materials had the discharging curve (shown in FIG. 16) that resembled the discharging curve (shown in FIGS. 10 and 11) of Example 1, the discharging capacity was approximately 85 μAh that was 15% less in the discharging capacity than the battery of Example 1. This was due to the fact, in Comparative Example 1, that the presence of acetylene black and electrolyte selected at an amount to provide an optimum composition with respect to iron olivine resulted in a decrease in the amount of active material to be contained per unit volume.

Next, as shown in FIG. 13, the discharging curve of the battery manufactured in Example 2 results in a pattern in the two stage having both the pattern resulting from graphite and spinel manganese with the voltage in the vicinity of 4.0 V and the pattern resulting from lithium titanate and spinel manganese with the voltage in the vicinity of 2.5 V. In this case, the state of charge of the battery can be easily detected in the same manner as that of Example 1. Further, even in the occurrence of over-discharging, the negative electrode potential is maintained for a while at a voltage of 1.5 V resulting from lithium titanate, resulting in an effect of suppressing the voltage potential from increasing to such a level to cause the current collector foil to be melted. Accordingly, the battery of Example 2 results in a battery that is strong against over-discharging.

In the meanwhile, although the battery manufactured in Comparative Example 2 has the discharging curve (see FIG. 18) that is similar to that of Example 2 (see FIG. 13), this battery has a capacity approximately half of that of Example 2. This is due to the fact that the composition of ink in Comparative Example is optimized as compared to lithium titanate and, so, reduction occurs in the amount of active material to be contained per unit volume.

As shown in FIG. 20, the discharging curve of the battery manufactured in Comparative Example 3 has substantially the same shape as the discharging curve (see FIG. 21) resulting from spinel manganese. Since this discharging curve smoothly varies in a mode different from those of Examples 1 and 2, a need arises for detecting the state of charge of the battery using a separate voltage detection circuit.

Consequently, it is understood that preparing ink with compositions optimum for respective active materials allows resulting ink to be applied to the current collector in an optimum deposition pattern for thereby enabling a battery with large energy to be manufactured. The reason why the deposition patterns can be concurrently printed on the same plane using the plurality of kinds inks is because of the fact that the ink jet printer is used, and the use of a general bar code or die coater makes it impossible to draw the deposition pattern.

As described above, since the structure of the presently filed embodiment contemplates to provide a structure including a stage in which the computer acquires the deposition pattern in case of applying a plurality of kinds of active materials, different in electrical characteristic, onto the discrete areas of the current collector, respectively, and another stage in which the active materials of the respective kinds are injected and deposited onto the current collector, as multiple particles, from the injection nozzles controlled by the computer in accordance with the deposition pattern, active materials of the plural kinds with different electrical characteristics can be applied to the current collector in accordance with the deposition pattern. This enables the secondary battery electrode to have a desired charging and discharging characteristic. That is, such a secondary battery electrode has the current collector applied with active materials of the plural kinds with different electrical characteristics in accordance with the deposition pattern, enabling to afford the battery with an arbitrary charging and discharging characteristic. Accordingly, with the secondary battery, battery unit and combined battery to which such an electrode is applied, the respective batteries are able to have a desired charging and discharging characteristic and, so, the vehicle on which such a battery is installed is able to have an improved running performance, safety and reliability.

The entire content of a Patent Application No. TOKUGAN 2003-174136 with a filing date of Jun. 18, 2003 in Japan is hereby incorporated by reference.

Although the invention has been described above by reference to a certain embodiment of the invention, the invention is not limited to the embodiment described above. Modifications and variations of the embodiment described above will occur to those skilled in the art, in light of the teachings. The scope of the invention is defined with reference to the following claims.

### INDUSTRIAL APPLICABILITY

As set forth above, according to the present invention, since a computer acquires a deposition pattern for depositing a plurality of kinds of active materials, different in electrical characteristic, discrete areas on a current collector and the computer enables injection nozzles to inject and deposit active materials of the respective kinds onto the current collector as multiple particles in accordance with the deposition pattern for forming an active material layer, a secondary battery electrode is able to have a desired charging and discharging characteristic. A secondary battery equipped with such electrodes can be applied not only to a vehicle primary power supply, in the form of combined batteries, with a desired charging and discharging characteristic but also to an electric power generator for industrial or domestic use, with a wide range of application being expected.

1. A method of manufacturing a secondary battery electrode having active materials on a current collector, comprising:
letting a computer acquire a deposition pattern for depositing a plurality of kinds of active materials, different in electric characteristic, onto discrete areas of a current collector, respectively; and
letting the computer allow injection nozzles to inject the plurality of kinds of active materials, as multiple particles, onto the current collector for deposition thereon, respectively, in accordance with the deposition pattern for thereby forming an active material layer.

2. The method according to clam 1, wherein the active material layer is formed by drying the plurality of kinds of active materials deposited onto the current collector.

3. The method according to clam 1, wherein the computer accesses to a memory device to read the deposition pattern stored therein for thereby acquiring the deposition pattern.

4. The method according to clam 3, wherein the computer is used and draws the deposition pattern on a display whereupon the deposition pattern drawn on the display is stored in the memory device to allow the computer to read the deposition pattern stored in the memory device for thereby acquiring the deposition pattern.

5. The method according to clam 1, wherein the deposition pattern allows the plurality of kinds of active materials to be located on the discrete areas of the current collector, respectively.

6. The method according to clam 1, wherein the deposition pattern allows the plurality of kinds of active materials to be regularly and periodically located on the discrete areas of the current collector, respectively, in an individual fashion.

7. An apparatus for manufacturing a secondary battery electrode having active materials on a current collector, comprising:
a computer generating a deposition pattern for depositing a plurality of kinds of active materials, different in electric characteristic, onto discrete areas of a current collector, respectively;
a memory device storing the deposition pattern generated by the computer;
injection nozzles injecting the plurality of kinds of active materials, as multiple particles, onto the current collector, respectively, in accordance with the deposition pattern stored in the memory device; and
a heater drying the plurality of kinds of active materials deposited on the current collector, respectively.

8. The apparatus according to claim 7, wherein the computer includes an input terminal inputting information for drawing the deposition pattern, a drawing section drawing the deposition pattern based on information inputted from the input terminal, and a display providing a display of the deposition pattern drawn by the drawing section.

9. The apparatus according to claim 7, wherein the deposition pattern is configured with a plurality of graphics, using colors allocated to the plurality of kinds of active materials, respectively, of which graphics different in color are located without overlapping one another.

10. The apparatus according to claim 7, wherein the deposition pattern is configured with a plurality of graphics, using colors allocated to the plurality of kinds of active materials, respectively, of which graphics different in color are regularly and periodically located to be separate from one another.

11. The apparatus according to claim 7, wherein the injection nozzles are independently allocated to the plurality of active materials, respectively.

12. The apparatus according to claim 7, wherein the injection nozzles are independently allocated to colors of a plurality of graphics forming the deposition pattern, respectively.

13. The apparatus according to claim 7, wherein the injection nozzles include propellant containers accommodating the plurality of kinds of active materials, respectively, and the propellant containers include a heater heating the active materials.

14. A secondary battery electrode comprising:
a current collector; and
an electrode layer formed on the current collector and including a plurality of kinds of active materials, different in electrical characteristic, the electrode layer being structured such that graphics associated with the plurality of kinds of active materials, respectively, are located on discrete areas of the current collector.

15. The secondary battery electrode according to claim 14, wherein the electrode layers are structured such that the graphics associated with the plurality of kinds of active materials, respectively, are regularly and periodically located on the current collector.

16. The secondary battery electrode according to claim 14, wherein the electrical characteristic includes a characteristic exhibiting the relationship between the amount of charging and output voltage of a secondary battery formed using the plurality of kinds of active materials.

17. The secondary battery electrode according to claim 14, wherein the secondary battery electrode is applied to a secondary battery.

18. The secondary battery electrode according to claim 17, wherein the secondary battery is connected in series, in parallel, or in combination of series and parallel to form a battery unit.

19. The secondary battery electrode according to claim 18, wherein the battery unit is connected in series, in parallel, or in combination of series and parallel to form a combined battery.

20. The secondary battery electrode according to claim 17, wherein at least one of a battery unit, formed of the secondary battery connected in series, in parallel, or in combination of series and parallel, and a combined battery formed of the battery unit connected in series, in parallel, or in combination of series and parallel is installed on a vehicle as a power supply.
